(19) United States
(12) Patent Application Publication
(10) Pub. No.: US 2011/0158459 A1
(43) Pub. Date: Jun. 30, 2011

(54) LOUDSPEAKER AND ELECTRONIC DEVICE INCORPORATING THE SAME

(75) Inventor: HWANG-MIAW CHEN, Tu-Cheng (TW)

(73) Assignee: FOXCONN TECHNOLOGY CO., LTD., Tu-Cheng (TW)

(21) Appl. No.: 12/714,550

(22) Filed: Mar. 1, 2010

(30) Foreign Application Priority Data
Dec. 25, 2009 (CN) 200910312271.X

(51) Int. Cl. H04R 1/00

(52) U.S. Cl. 381/399

(57) ABSTRACT

A loudspeaker includes a frame, a yoke physically associated with the frame and a sheet attached to an outer surface of the yoke. The sheet is made of an electrically conductive material. An electronic device incorporating the loudspeaker is also provided.

### BACKGROUND

1. Technical Field

The disclosure generally relates to electroacoustic transducers, and particularly to a loudspeaker used in an electronic device.

2. Description of Related Art

With the continuing development of audio and sound technology, loudspeakers have been widely used in electronic devices such as mobile phones, computers, televisions and other devices providing audio capabilities.

There are many different types of loudspeakers, e.g., electrostatic loudspeakers, piezoelectric loudspeakers, and moving-coil loudspeakers. Moving-coil loudspeakers are very popular due to their low cost and wide sound range.

A typical moving-coil loudspeaker includes a diaphragm, a voice coil joined to the diaphragm, a magnet and a circuit board. When an oscillating electric current is supplied to the voice coil from the circuit board, a corresponding oscillating magnetic field is generated by the voice coil. The oscillating magnetic field is superimposed onto a magnetostatic field generated by the magnet. This compels the voice coil to oscillate, and the oscillating voice coil drives the diaphragm to push ambient air to generate sound. However, in this process, static electricity is easily generated due to friction between the diaphragm and the ambient air. The static electricity and the oscillating electric current in the voice coil interfere with each other. Thus, the sound output quality of the loudspeaker may be adversely affected. Even worse, the static electricity may burn out the circuit board and the voice coil electrically connected with the circuit board.

What is needed, therefore, is a loudspeaker and an electronic device incorporating the loudspeaker which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled, isometric view of a loudspeaker in accordance with one embodiment of the disclosure.

FIG. 2 is a cross sectional view of the loudspeaker of FIG. 1, taken along line II-II thereof.

FIG. 3 is an exploded, isometric view of the loudspeaker of FIG. 1.

FIG. 4 is a cross sectional view of an electronic device incorporating the loudspeaker of FIG. 1.

### DETAILED DESCRIPTION

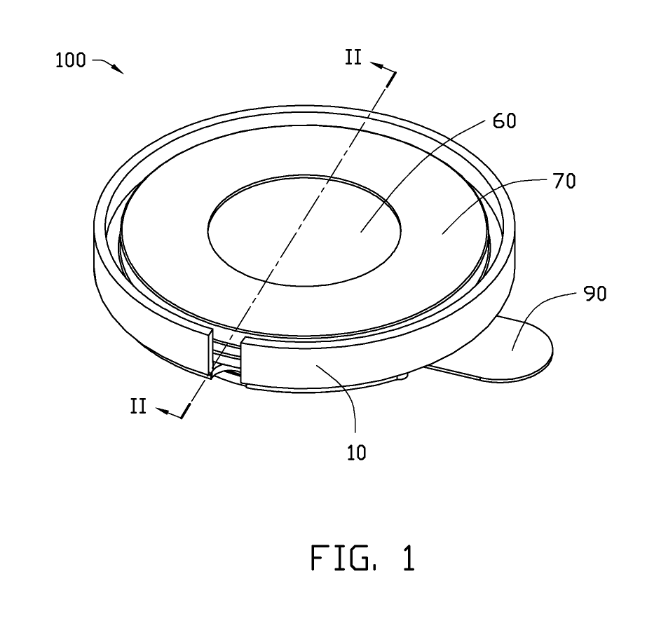

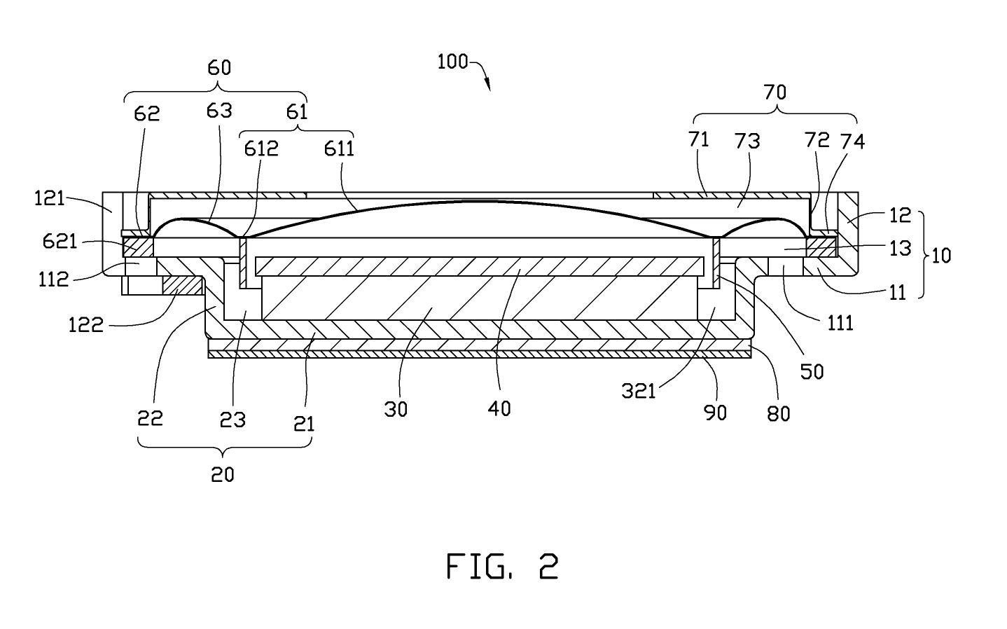

Referring to FIGS. 1 and 2, a loudspeaker 100 in accordance with one embodiment of the disclosure is shown. The loudspeaker 100 includes a frame 10, a yoke 20 engaged with the frame 10, a magnet 30 in the yoke 20, a washer 40 on the magnet 30, a voice coil 50 surrounding the magnet 30, a diaphragm 60 attached to the frame 10, a cover 70 covering the diaphragm 60, and a sheet 80 attached to the yoke 20.

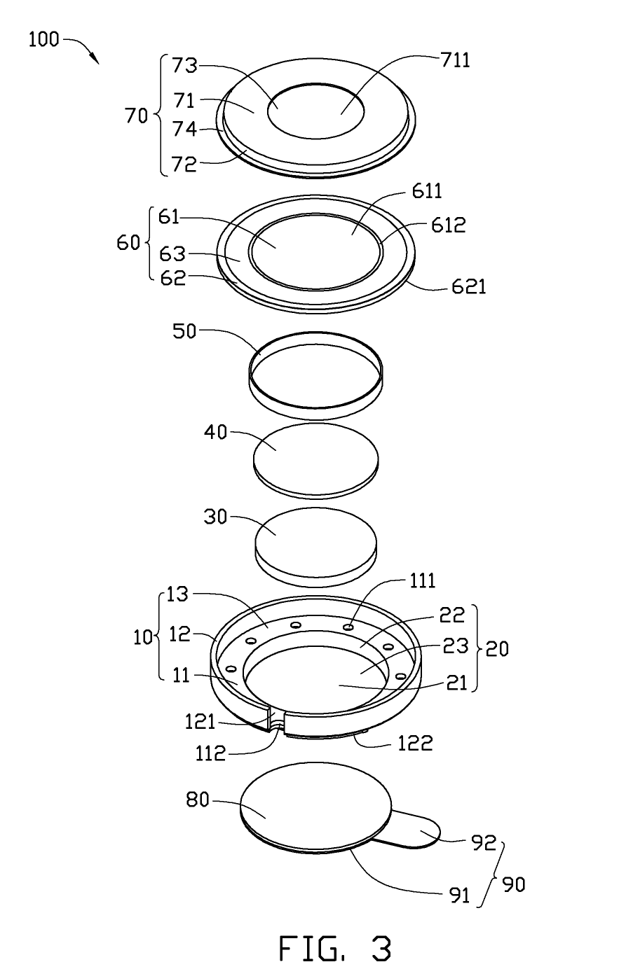

Referring also to FIG. 3, the frame 10 is substantially bowl-shaped, and includes a base plate 11 and a side plate 12 extending upwardly and perpendicularly from an outer periphery of the base plate 11. The base and side plates 11, 12 cooperatively define a receiving space 13 therebetween. The base plate 11 is annular, and the yoke 20 is located at a center of the base plate 11. A plurality of through holes 111 are defined in the base plate 11 surrounding the yoke 20, to improve the sound quality factor and adjust the sound sharpness of the loudspeaker 100. The base plate 11 defines a semicircular slot 112 at the outer periphery thereof. The side plate 12 is annular. The side plate 12 defines a through slot 121 spanning an entire height thereof. The through slot 121 communicates with the semicircular slot 112 of the base plate 11. Therefore, a terminal (not shown) of the voice coil 50 can extend through the through slot 121 and the semicircular slot 112 to electrically connect to a circuit board 122 located at a bottom surface of the base plate 11.

The yoke 20 is substantially bowl-shaped, and includes a circular base wall 21 and a sidewall 22 extending upwardly and perpendicularly from an outer periphery of the base wall 21. The base wall 21 and the sidewall 22 cooperatively define a receiving chamber 23 therebetween. The receiving chamber 23 of the yoke 20 communicates with the receiving space 13 of the frame 10. A top end of the sidewall 22 of the yoke 20, namely at an open end of the yoke 20, is located at an inner periphery of the base plate 11 of the frame 10. In this embodiment, the yoke 20 is integrally formed with the frame 10 as a single, one-piece, monolithic body without any seams.

The magnet 30 is disk-shaped (or cylindrical), and is attached to a top surface of the base wall 21 of the yoke 20. The washer 40 is circular and laminar, and attached to a top surface of the magnet 30. The magnet 30 and the washer 40 are received in the receiving chamber 23 of the yoke 20, and are coaxial with the yoke 20. An outer diameter of the magnet 30 and an outer diameter of the washer 40 are smaller than an inner diameter of the yoke 20. Thereby, outer peripheral side surfaces of the magnet 30 and the washer 40, and the side wall 22 of the yoke 20, cooperatively define an annular gap 321 therebetween, for accommodating a bottom end of the voice coil 50 therein. The voice coil 50 is cylindrical and hollow. The voice coil 50 surrounds the magnet 30 and the washer 40 and is movable in the annular gap 321.

The diaphragm 60 is circular, and has a thin cross-section, with the thickness of the diaphragm 60 being substantially constant throughout the cross-section. The diaphragm 60 includes a central area 61 in a center thereof, a joint area 62 at an outer periphery thereof, and a connecting area 63 between the central area 61 and the joint area 62. The central area 61, the joint area 62 and the connecting area 63 are coaxial. The central area 61 is circular. The central area 61 includes a dome-shaped central section 611 at a center thereof, and a coil connecting section 612 at an outer periphery of the central section 611. The coil connecting section 612 is annular and planar, and has a width larger than a thickness of a cylindrical wall of the voice coil 50. A top side of the voice coil 50 is joined to a bottom surface of the coil connecting section 612.

The connecting area 63 is disposed at an outer periphery of the coil connecting section 612, and is curved upwardly to form an annular bulge. The joint area 62 is annular and planar, and disposed at an outer periphery of the connecting area 63. A copper ring 621 is attached to a bottom surface of the joint area 62, to increase the rigidity of the diaphragm 60. The copper ring 621 has a width substantially equal to that of the joint area 62. A bottom surface of the copper ring 621 is attached to the base plate 11 of the frame 10, to thereby join the diaphragm 60 on the frame 10.

The cover 70 has substantially an inverted bowl-shape. The cover 70 covers the diaphragm 60, and is received in the receiving space 13 of the frame 10. The cover 70 includes a top wall 71, a sidewall 72 extending downwardly and perpendicularly from an outer periphery of the top wall 71, and a flange 74 extending outwardly and perpendicularly from a bottom end of the sidewall 72. The top wall 71 and the sidewall 72 cooperatively define an accommodating chamber 73 therebetween. The top wall 71 is annular and planar, and defines a sound outlet 711 in a central area thereof. Sound generated by the loudspeaker 100 is transmitted to the outside of the loudspeaker 100 through the sound outlet 711. A top surface of the top wall 71 is coplanar with a top end of the frame 10. The flange 74 is annular and planar. A bottom surface of the flange 74 is attached to a top surface of the joint area 62 of the diaphragm 60. The central and connecting areas 61, 62 of the diaphragm 60 are accommodated in the accommodating chamber 73.

The sheet 80 is made of an electrically and heat conductive material, such as metal. In this embodiment, the sheet 80 is made of copper. The sheet 80 is circular and laminar. A top surface of the sheet 80 is attached to a bottom surface of the base wall 21 of the yoke 20. The sheet 80 has an outer diameter substantially equal to that of the base wall 211 of the yoke 20. A protective layer 90 is attached to a bottom surface of the sheet 80. The protective layer 90 includes an overlay 91, and a tab 92 extending outwardly and radially from an outer periphery of the overlay 91. The overlay 91 is circular, and has an outer diameter substantially equal to that of the sheet 80. The overlay 91 is attached to the bottom surface of the sheet 80, for preventing contamination of the sheet 80 by dust or other impurities.

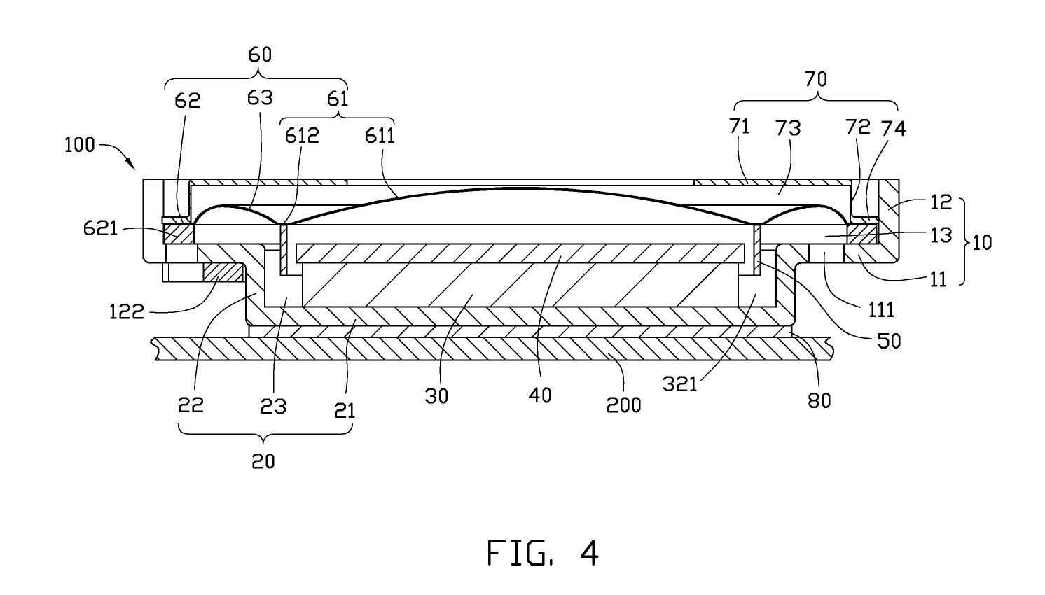

Referring to FIG. 4, an electronic device incorporating the loudspeaker 100 is shown. During assembly of the electronic device, the protective layer 90 of the loudspeaker 100 is firstly peeled away from the sheet 80 via the tab 92. The loudspeaker 100 is secured on an enclosure 200 of the electronic device, with the bottom surface of the sheet 80 of the loudspeaker 100 attached to a top surface of the enclosure 200.

In the present loudspeaker 100 and the electronic device incorporating the loudspeaker 100, the electrically conductive sheet 80 is attached to the bottom surface of the yoke 20. Thus, static electricity generated due to vibration of the diaphragm 60 can be transferred from the frame 10 and the yoke 20 to the sheet 80, and thence to the enclosure 200 of the electronic device to which the sheet 80 is attached. This avoids static electricity and an oscillating electric current in the voice coil 50 interfering with each other, and thus improves the sound output quality of the loudspeaker 100. In addition, the circuit board 122 and the voice coil 50 electrically connected with the circuit board 122 are protected from being burnt out by static electricity, whereby the reliability of the loudspeaker 100 is improved. Furthermore, the electrically conductive material of the sheet 80 of the loudspeaker 100 has high heat conductive performance Thus, heat generated due to friction between the oscillating diaphragm 60 and the ambient air during operation of the loudspeaker 100 can be transferred from the frame 10 and the yoke 20 to the sheet 80, and thence to the enclosure 200 of the electronic device.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A loudspeaker, comprising:
a frame;
a yoke physically associated with the frame; and
a sheet attached to an outer surface of the yoke, the sheet made of an electrically conductive material.

2. The loudspeaker of claim 1, wherein the electrically conductive material of the sheet is also heat conductive.

3. The loudspeaker of claim 2, wherein the sheet is made of metal.

4. The loudspeaker of claim 3, wherein the sheet is made of copper.

5. The loudspeaker of claim 1, wherein the yoke comprises a base wall and a sidewall extending upwardly from the base wall, and a top surface of the sheet is attached to a bottom surface of the base wall of the yoke.

6. The loudspeaker of claim 5, further comprising a protective layer, wherein the protective layer is attached to a bottom surface of the sheet.

7. The loudspeaker of claim 6, wherein the protective layer comprises an overlay and a tab extending outwardly from an outer periphery of the overlay, the overlay is attached to the bottom surface of the sheet, and the tab extends beyond the sheet.

8. The loudspeaker of claim 5, wherein a top end of the sidewall of the yoke is physically associated with an inner periphery of the frame, the base wall and the sidewall of the yoke cooperatively define a receiving chamber therebetween, and a magnet and a washer are received in the receiving chamber of the yoke.

9. The loudspeaker of claim 8, further comprising a diaphragm and a voice coil joined to the diaphragm, wherein the frame defines therein a receiving space in communication with the receiving chamber of the yoke, the diaphragm is received in the receiving space of the frame, and the voice coil is movably received in the receiving chamber of the yoke.

10. The loudspeaker of claim 9, wherein the diaphragm comprises a joint area at an outer periphery thereof, a copper ring is attached to the joint area of the diaphragm, and the joint area of diaphragm is thereby engaged with the frame via the copper ring.

11. The loudspeaker of claim 9, wherein the voice coil is movable in a gap between the magnet and the sidewall of the yoke.

12. An electronic device, comprising:
an enclosure; and
a loudspeaker comprising a frame, a yoke physically associated with the frame, and a sheet made of an electrically conductive material, one side of the sheet attached to an outer surface of the yoke, and an opposite side of the sheet attached to the enclosure.

13. The electronic device of claim 12, wherein the sheet is made of a heat conductive material.

14. The electronic device of claim 13, wherein the sheet is made of metal.

15. The electronic device of claim 14, wherein the sheet is made of copper.

16. The electronic device of claim 12, wherein the yoke comprises a base wall and a sidewall extending upwardly form the base wall, a top surface of the sheet is attached to a bottom surface of the base wall of the yoke, and a bottom surface of the sheet is attached to a top surface of the enclosure.

17. The electronic device of claim 12, further comprising a diaphragm, a voice coil joined to the diaphragm, and a magnet received in the yoke, wherein the diaphragm is engaged with the frame, and the voice coil is movable in a gap between the magnet and a peripheral wall of the yoke.
